(19) United States
(12) Patent Application Publication
(10) Pub. No.: US 2014/0093862 A1
(43) Pub. Date: Apr. 3, 2014

(54) METHOD OF SIMULATING AN ENVIRONMENT

(71) Applicant: Daniel J. LAUDERDALE, Wentzville, MO (US)

(72) Inventor: Daniel J. LAUDERDALE, Wentzville, MO (US)

(21) Appl. No.: 14/045,641

(22) Filed: Oct. 3, 2013

Related U.S. Application Data
(60) Provisional application No. 61/709,307, filed on Oct. 3, 2012.

(51) Int. Cl. B44C 1/10

(52) U.S. Cl. CPC B44C 1/105
USPC 434/428

(57) ABSTRACT

A method of simulating an environment has a back panel and at least one side panel. The method then selects a theme for the panels, selects a primary image for the back panel, and selects a related secondary image for the side panel. The primary and secondary images are asymmetric for upright installation. The primary image then identifies its front end and its back end and the secondary image does so also in this method. The method then aligns the front ends to the back ends. With the various ends aligned, the back panel is then installed upon a wall in a closet or a corner. With the back panel installed, the side panel is installed upon either the front end or the back end of the back panel. The side panel and the back panel create surroundings for a child to play in using his imagination to explore.

### CROSS-REFERENCE TO RELATED APPLICATION

This non-provisional application claims priority to the pending provisional application Ser. No. 61/709,307 filed on Oct. 3, 2012 and is owned by the same inventor.

### BACKGROUND OF THE INVENTION

The method for simulating an environment generally relates to decoration of children's rooms and more specifically to decorating a closet. This method utilizes an attachable material to make surroundings inside a closet, at a room corner, or other corner that simulates an environment and allows for the exploration of imagination through interactive illustrations. The present invention creates an interactive environment that also for the exploration of the user's imagination through interactive illustrations. The present invention provides unique features and options that assist the user in creating a place they can call their own.

Since the time of cave paintings, people, even children, have decorated their living spaces. Children have generally taken a back seat to decorating their rooms when of tender years but parents may allow children a decorating role when older.

Everyone wants a place they can call their own. Building a structure or dedicating usable living space can be costly and frequently does not appear as an option to most parents. Designing an environment has its difficulties. Creating functionality in an environment also has its difficulties when repurposing a space along with costs.

At night, in bad weather, when friends visit, and when a parent says so, a child is in his room. Children can play in their rooms with toys, with each other, and with games of all description. Some children may even play in a closet if a room has one. Other children may play in a wardrobe or other storage furniture. A closet though looks like a closet and for some children, the closet has an appearance far from tidy. Eventually, a child may become bored playing in his room. The child may make that feeling known to his parents, quietly or more often loudly.

### DESCRIPTION OF THE PRIOR ART

Parents, and to some extent children, have decorated their rooms to make a pleasant place to play, to sleep, and to grow up. The decorations include paint, posters, wall coverings, stickers, pictures, artwork, and the like. However, closets generally remain for storage and see little if any decoration. Corners of rooms and corners formed by furniture adjacent to a wall often accumulate the stuff of childhood rather show a decoration. Closets and corners generally avoid decorative effort.

From time to time, a parent encourages a child to get out of his room and to participate with other children at play. The children form an ad hoc club and pursue various adventures dreamt up by the children themselves. Such clubs often acquire a clubhouse as the meeting place for the children before, during, and after an adventure. The adventure has its limits, if any, by the imagination of the children participating in the adventure.

The clubhouse may take various forms. Other clubhouses have surfaced over the years as people built specific building structures, used refrigerator boxes, set up tents, installed playgrounds, converted parts of or whole garages, remodeled parts of or whole basements, and the like.

Prior art clubhouses often have their expensive construction and ongoing operating costs. Some existing clubhouses require extensive assembly as well. Other existing clubhouses present less desirable features to children and parents parents with their simplistic appearance that does not allow for the exploration of imagination by way of an easily installed functional environment. Users, that is, children, do not become involved in other clubhouses because of their lack of an easily installed environment that allows for exploration of a child's imagination while remaining affordable.

The publication to DeLong, No. 2007/0084100, shows a wallpaper picture frame. This wallpaper has two sheets: a front sheet and a back sheet. The front sheet has a window for display of a photograph or other image placed within the front sheet.

Dronzek's publication, No. 2007/0059476, provides a clear decorative element of polymeric film. This transparent film allows for transmission of the underlying image to the viewer.

The publication to Sobonya, No. 2006/0213101, has a temporary wallpaper banner that relates to a theme such as a holiday, season, birthday, or other life event. This wallpaper has a generally elongated form with two opposite surfaces and removable adhesive upon the second of the surfaces.

Greenstein's U.S. Pat. No. 6,718,579, describes a covering with flip panels that may see use upon a wall, bed, or floor. The flip panels allow a user to select from two different surface designs as the user folds one corner of a layer upon the flip axis to another opposite corner.

The U.S. Pat. No. to Schwarz et al, U.S. Pat. No. 5,620,764, shows a wall covering system that has a substrate and at least one appliqué. The appliqué is of electrostatic cling material that cooperates with a surface of the substrate. The opposite surface of the substrate then has a permanent adhesive for its attachment to a wall surface.

And, the Burton U.S. Pat. No. 3,715,264 describes a wall covering of multiple layers. The layers include a decorated paper sheet, a layer of polymeric material, and an open weave fabric where the fabric lessens the tendency of the layers to curl in the presence of water based adhesive.

The present invention overcomes the disadvantages of the prior art and provides a method of simulating an environment readily installed by a parent for a child to explore. The present invention provides its method upon existing wall construction without damaging a wall. The present invention also utilizes a method that installs readily upon a wall with a proper orientation.

### SUMMARY OF THE INVENTION

Generally, the method for simulating an environment utilizes a back panel and at least one side panel. The method then selects a theme for the panels, selects a primary image for the back panel, and selects a secondary image for the side panel related to the primary image. The primary and secondary images each have asymmetry and alignment features to foster proper upright and left to right installation of two or more panels. The primary image, then identifies its front end and its back end and the secondary image also identifies its front end and back end. The method then checks the alignment of the front ends and back ends of the primary and secondary images. The front ends and back ends aligned, the back panel is then installed upon a wall in a closet or a corner. With the back panel installed, the side panel is installed upon either the front end or the back end of the back panel. The side panel and the back panel cooperate and create an environment in which a child may play using his imagination to explore the environment.

The present invention, also called The Closet Clubhouse™, simplifies the struggle to repurpose a space or a room into an environment desirable to children and allows for the interchange of environments with ease. The present invention allows a user, or parent, to customize a previously unused area into a place children can call their own. This out of the ordinary environment allows the exploration of imagination while remaining cost effective. The present invention utilizes a design, installation or setup, and functionality of a selected environment of a simplified nature. The present invention allows for ready selection, ease of setup, and plenty of fun with the environment installed.

The present invention reduces costs, simplifies design, eases set up, speeds removal, and improves function by increasing a user's interest through interactive illustrations and the use of add-ons or additional items.

There has thus been outlined, rather broadly, the more important features of the invention in order that the detailed description thereof that follows may be better understood and that the present contribution to the art may be better appreciated. The present invention also includes a front end and a back end upon each panel, a reverse surface upon the back panel that has a grid for assisting a user during trimming, a plurality of decals, asymmetric images, and images cues denoting an upright orientation. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a method for simulating an environment that installs readily in a closet or other location with a corner.

Another object is to provide such a method for simulating an environment that allows for easy selection of a desired design.

Another object is to provide such a method for simulating an environment that installs easily.

Another object is to provide such a method for simulating an environment that functions well with children of all ages.

Another object is to provide such a method for simulating an environment that detaches from a supporting surface for ready replacement.

Another object is to provide such a method for simulating an environment that has a minimum of components for manufacturing and later usage by unskilled labor.

Another object is to provide such a method for simulating an environment that has a low cost of manufacturing and high affordability so the purchasing parents, relatives, distributors, and retailers can readily buy the method through stores and supply sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 describes a perspective view of the invention shown in room use;

FIG. 2 describes a perspective view of the invention shown in closet use;

FIG. 3 shows a sectional view of the invention; and,

FIG. 4 provides a perspective view of the invention showing removal of the release layer from the backing;

FIG. 5 describes an exploded view of panels used by the invention;

FIG. 6 illustrates a rear view of a back panel used by the invention;

FIG. 7 shows a flow chart of the invention preparing panels; and,

FIG. 8 shows a flow chart of the invention for installing panels.

The same reference numerals refer to the same parts throughout the various figures.

### DESCRIPTION OF THE PREFERRED EMBODIMENT

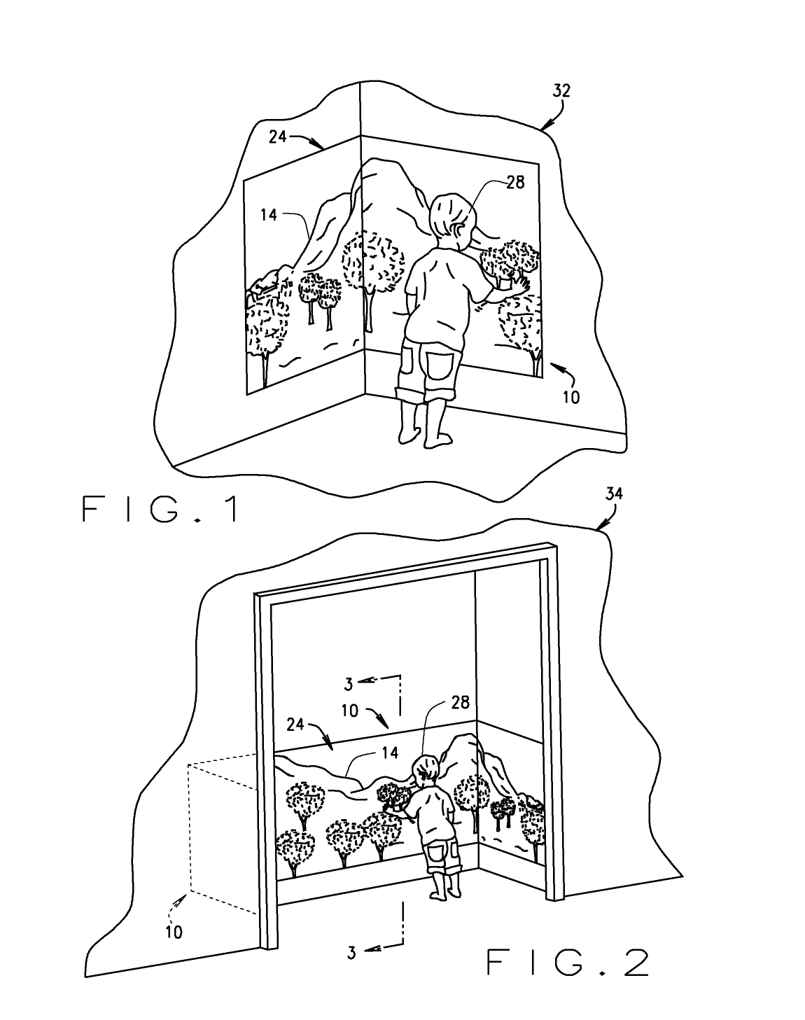

The present art overcomes the prior art limitations by providing a method for simulating an environment, such as shown in FIG. 1, that overcomes the limitations of prior devices and methods for providing a clubhouse or other environment for children to explore.

The present invention, or Closet Clubhouse™, utilizes the following components in its method:

First, an attachable surrounding made of impermeable interactive illustrations;

Second, an adhesive backing with a non-adhesive covering, or release layer;

Third, a laminated clear coat applied to the viewable surface during printing;

Fourth, impermeable adhesive decals suitable for arrangement on the interactive illustrations;

Fifth, optional shelving that further enhances functionality;

Sixth, optional lighting through light emitting diode, LED, or fiber optics where the lighting includes black light to stimulate a glow from select elements in the surrounding and the glow comes from an ink such as Invisible Lemon D made by DayGlo Color Corp. of Cleveland, Ohio;

Seventh, sound components, such as speakers, wiring, and electrical components;

Eighth, optional ceilings from a retractable illustration used as a ceiling covering;

Ninth, optional audible story lines programmed with item 7 to further the interaction of a user with the present invention; and,

Tenth, optional software applications that further enhance the functionality of the present invention.

These components have the relationship beginning with a user measuring the attachable surrounding and form fitting it against a desired area, that is, surface. A user than affixes the attachable surround to a surface, such as a wall, of the desired area by removing a release layer and pressing the adhesive backing upon the wall. Upon removal of the release layer and installation of the attachable surrounding with its laminated coating properly attached by way of the adhesive backing upon a wall, the present invention has been installed. Next, the decals may then take an arrangement as a user places, or affixes, them to the surrounding to enhance the functionality of the present invention. The present invention also has various options to enhance its functionality such as shelving used to support objects, lighting to illumination parts or all of the surrounding or provide visual effects, sound components to provide various effects themed to effects themed to the illustrations upon the surrounding, extendible ceilings that further establish a smaller space for realistic effects, such as a hold in a ship, audible story lines that allow continuously changing participation by the users, and software for enhanced interaction. The software operates upon desktop computers, applications on mobile devices, direct streaming over the Internet, and the like.

As briefly described about the drawings above, the present invention includes these components:
10 surrounding that simulates an environment and allows the exploration of imagination through interactive illustrations;
12 layer;
14 printable ink;
18 adhesive backing;
20 release layer, or non-adhesive covering;
22 laminated coating;
24 front surface;
26 rear surface;
28 user, shown as a child;
30 installer, typically a parent;
32 a corner of a room; and,
34 a closet.

FIG. 1 shows a corner 32 of a room decorated with the method of the present invention 1. The corner forms from two adjacent walls 32a meeting at a generally perpendicular angle as specified by building code or architectural plans. Each wall has a surrounding 10 affixed to it and each surrounding displays its front surface 24 that has an image made from ink 14 or other printing methods. A user, such as a child 28, can then view the image on the surrounding 10 and use his imagination, right there in the corner of a wall.

FIG. 2 then provides a perspective view of a closet 34 within a room and the method of the present invention 1 allows for decorating the closet. The closet has a generally rectangular shape governed by building code or architectural plans. The closet generally has two sidewalls 32b and a back wall 32c. The closet generally has a height comparable to that of a door, approximately seven feet. As in FIG. 1, any closet may have a surrounding 10 affixed within it as shown. Each surrounding displays its front surface 24 that has an image made from ink 14 or other printing methods. The surrounding extends from one sidewall 32b, across the back wall 32c, and returns to the other sidewall 32b as shown. A user, such as a child 28, can then view the image on the surrounding 10 and use his imagination for various adventures and exploration, right there in the closet. If needed a parent, or the child, can close the closet door once play has concluded to present a clean appearance to the room.

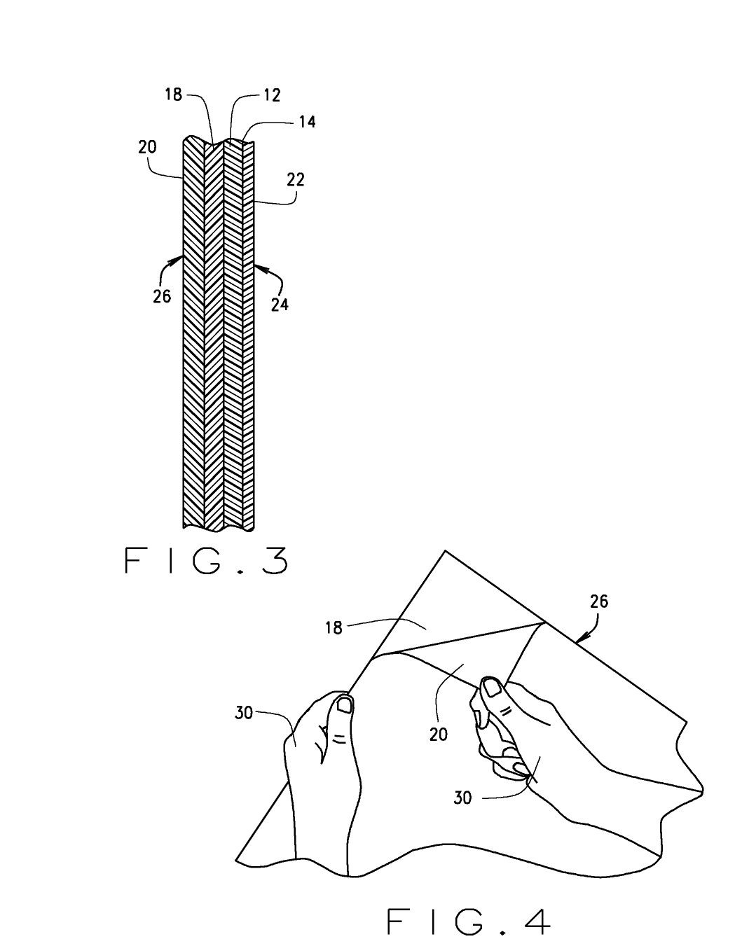

Each surrounding 10 has a printed form upon a flexible, planar material. The material is suitable for printing using common printing methods and techniques, such as for banners, larger posters, billboards, and the like. FIG. 3 shows a sectional view through the material. As previously described, each surrounding 10 has its front surface 24 visible to a user by installation with the method of the present invention. The front surface is the outer surface of a laminated coating 22 upon the layer of ink as at 14. The ink may take many forms as suggest by the printing method utilized, and the images desired as later described. In an alternate embodiment, the invention utilizes lighting, such as black light, that illuminates the surrounding 10 and later decals so that they appear to glow to a user. The ink used in the alternate embodiment includes Invisible Lemon D made by DayGlo Color Corp. of Cleveland, Ohio The ink layer 14 is upon a layer or substrate 12. The substrate is generally flexible and capable of rolling for shipment of the surrounding. The substrate has two opposite and spaced apart surfaces: its front surface 12a and its back surface 12b. The substrate receives the ink layer 14 as shown upon its front surface 12a and an adhesive backing 18 upon its back surface 12b. The adhesive backing bonds to the back surface 12b and remains ready for adhering to a wall surface upon installation. The substrate can be made from various materials and the adhesive backing comprise various compounds including a Flexible Vinyl with Ultra Low Tack Removable Adhesive made by R & D Industries, Inc. Alternatively, the adhesive backing 18 includes solvent acrylics, pressure sensitive adhesives, such as those in Controltac® Graphic Film with Comply® of 3M of St. Paul, Minn., and the like. Upon the adhesive backing 18, outwardly from the back surface 12b of the substrate 12, and opposite the ink layer 14, the material has a release layer 20. The release layer covers the adhesive backing 18 during manufacturing, rolling, and shipping of the material to its installation location. The release layer, opposite the adhesive backing, defines the rear surface 26 of the material as seen by an operator or other person installing the material following the invention. The rear surface excludes a printed image as upon the front surface of the material. The substrate of R & D Industries, Inc. readily removes from such surfaces as painted walls, wallpaper, and wood paneling. The R & D Industries Flexible Vinyl accepts a topcoat for improved ink adhesion, as through the ink layer 14, for such printing methods as offset, ultraviolet, lithographic, flexographic, and the like.

FIG. 4 then shows an operator, such as a parent preparing the material for its installation. The operator sees the rear surface 26 and not the front surface in this figure. The operator 30 grips a corner of the release layer 20, typically a corner towards the top of the image. The operator then gently pulls the release layer to expose the adhesive backing 18. The operator then positions the exposed adhesive backing on a wall 32a, back wall 32b, or sidewall 32c. The operator then adjusts the material so that it has a horizontal orientation relative to the floor of the closet. An operator may use a level, not shown, or other tool to assist in attaining the desired orientation.

Turning to FIG. 5, the surrounding 10 of the closet installation in FIG. 2 is shown in an exploded view with a playing field, or back panel 40, and two dollhouse, or side panels 41. The back panel is generally rectangular with a width 40a, generally proportional to the width of a closet and a height 40b, where the width exceeds the height. The back panel has a generally planar form attained upon its installation upon a wall 32a as previously shown. The back panel has a front end 42 here shown towards the left of the figure and a mutually parallel and spaced apart back end 43 here shown towards the right of the figure. The front end and the back end generally extend parallel to the height of the back panel, that is, perpendicular to the width, and each has its own width 42a less than the width 40a of the back panel. The front end and the back end each have the same height 40b as the back panel which exceeds the width 42a of each. The back panel may have singled piece construction or up to three piece construction as in two or more subpanels each generally of lesser width than the width 40a of a complete back panel.

As shown in FIGS. 1, 2, the surrounding has an image upon it. FIGS. 1, 2 showed a woodland image however, the image may take a variety of forms. The image begins upon the back panel 40 and extends to the side panels 41 continuously so that a child can play within the surrounding and immerse himself in his imagination. The back panel has a primary image 44 and each side panel has a secondary image 45. The primary image has left to right asymmetry. The asymmetry appears particularly in the front end 42 and the back end 43 so that both ends appear different and properly oriented for the primary image. For example, the primary image may include a sailing ship with a mast, such as a pirate ship. The pirate ship in the image has a forecastle and a poop deck mutually spaced apart and with the poop deck at greater elevation above the gunwale than the forecastle. As another example, the primary image may include a castle with various towers and walls. The towers and walls on the front end differ from those on the back end. As another example, a cavern with a dragon may serve as the primary image and the dragon may be closer to the front end than the back end. The primary image has its asymmetry shown by the portion of the image upon the front end 42 having a lesser height than the portion of the image upon the back end 43. The portion of the primary image upon the front end denotes the left of the environment depicted in the surrounding while the portion of the primary image upon the back end denotes the right of the environment depicted. The asymmetry in the primary image allows a child to play in front of the image and imagine the primary image in motion, such as the pirate ship, or the dragon in a primary image moving to the right. The primary image also includes alignment features, for example sky, waves, dragon wings or legs, tower tapers, wall crenellations, and the like. These alignment features denote up in the image. Most users and children recognize these alignment features, almost subconsciously, and denote them as indicating up in an image. The present invention utilizes an image having these alignment features and asymmetry to guide the operator during installation of the back panel and to stimulate the imagination of a user playing within the surrounding.

The back panel 40 has its front end 42 and back end 43, each with a slightly different, that is, asymmetric portion of the primary image upon them. The front end 42 has a front portion of the primary image and the back end 43 has a back portion of the primary image. On the back panel, the front end is spaced spaced apart from the back end. The differences in the images on the two ends correspond with the side panels 41 being interchangeable. Each side panel also has a front end 46 and a spaced apart back end 47. Also, on the side panel, the front end is spaced apart from the back end. The front end 46 is generally upon the left of each side panel when viewing the secondary image the front and the mutually parallel and spaced apart back end 47 shows towards the right of each side panel when viewing the secondary image from the front. Each front end and each back end generally extend parallel to the height of each side panel, that is, perpendicular to the width 41a of a side panel, and each has its own width 46a less than the width 41a of the side panel. The front end and the back end each have the same height 41b as the back panel which exceeds the width 46a of each. Each side panel has a single piece construction.

The side panel 41 has its front end 46 and back end 47, each with a slightly different, that is, asymmetric portion of the secondary image. The front end 46 has a front portion of the secondary image and the back end 43 has a back portion of the secondary image. Each panel has a secondary image related to the primary image. For example, the secondary image may include a beach or dock, a plain or forest, tunnels or caverns, other mountains, and the like. The secondary image aligns with the primary image so a user feels surrounded and immersed into an environment formed by the primary and secondary images. The user does not see any gaps or misplacements between the primary and second images such as at a corner. As mentioned above, each side panel has a front end 46 and a back end 47. The front end 46 of a side panel 41 abuts the back end 43 of the back panel 40, and the back end 47 of a side panel 41 abuts the front end 42 of the back panel 40. Because of the abutting of the various ends to align the side panel to the back panel, the front end 46 differs noticeably from the back end 47 of a side panel. For example, in the pirate ship theme with its ship its ship shown in the primary imagine on the back panel, the front end 46 can be waves as that end corresponds with the poop deck shown on the back end 43 of the back panel while the back end 47 can be a beach which corresponds with the forecastle shown on the front end 42 of the primary image as a ship often has its bow with forecastle towards the shore. As another example, in a spaceship theme with the hull of a spacecraft in the primary image on the back panel, the front end 46 can be contrails as that end corresponds with the jets shown on the back end 43 of the back panel while the back end 47 can be a nose cone which corresponds with the cockpit shown on the front end 42 of the primary image as a space craft often has its crew towards the leading or forward portion of the craft. The secondary image has its asymmetry shown by the portion of the image upon the front end 46 having a greater height than the portion of the image upon the back end 47. Because of the differences, the asymmetries, in the portions of the secondary image on the back end and the front end of the side panels, the side panels can be interchanged to either wall of a closet. This allows an operator to focus attention on installing the back panel and then merely placing side panels adjacent to the ends of the back panel as opposed to precisely selecting an individual side panel. The ability to interchange the side panels also permits installation of the surrounding 10 in a left hand or a right hand corner as in FIG. 1 with less worry over the secondary image.

The back panel and the side panels may also accept various decals 70 placed upon them. The decals have much smaller width and height than the side panel. The decals typically have a size and shape to fit within the primary image and the secondary image. For example, decals may include geometric shapes, polygons, pirates in human form, ship cargo as crates and barrels, knights to take on dragons and to approach castles, princesses to be in castles, horses, spacemen and containerized cargo, and the like. The decals have a generally planar form of similar substrate as the back panel and the side panels. The decals have their shape from a contour cut. The decals then connect to the back panel and the side panel utilizing weak adhesives, magnetism, electrostatic cling, and other methods that allow for adhesion without leaving a residue. The decals include their substrates made by GPA® of McCook, Ill. such as 4 Mil Glossy clear flexible Vinyl, top-coated. Preferably, the decals adhere using a low tack adhesive so that the decals have a releasable adhesion, or connection, to the back panel. The decals include printing compatible with the primary image and the secondary image of the surrounding. The decals can be various shapes and sizes as well.

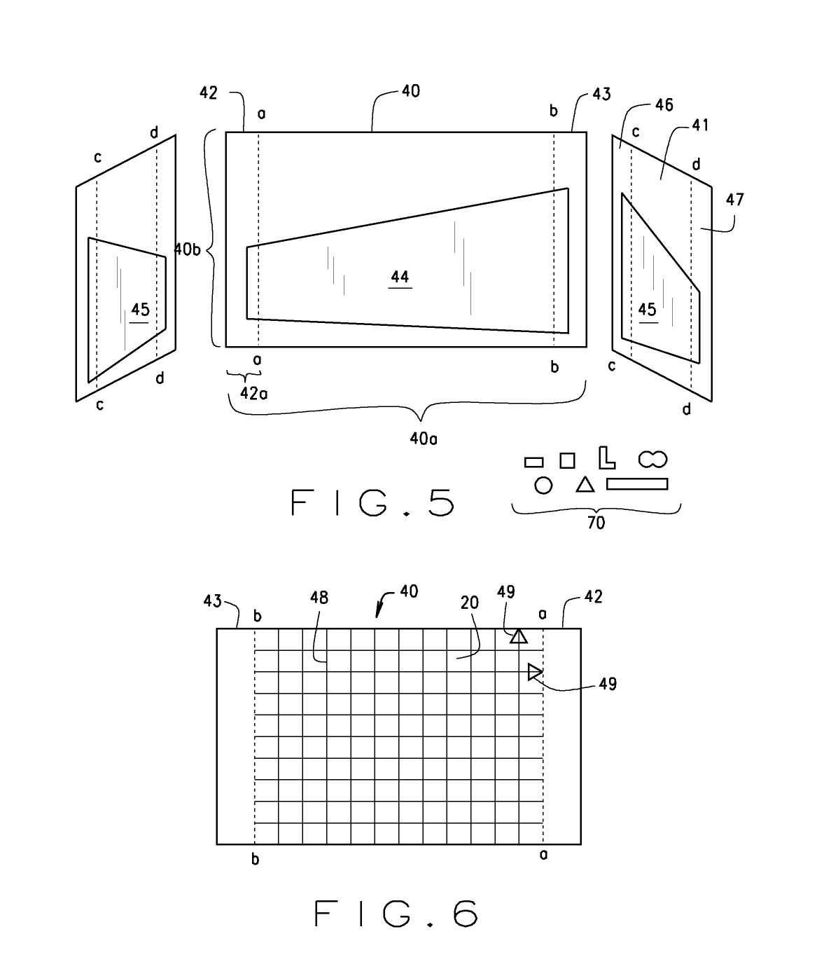

FIG. 6 shows a rear view of the back surface 26 of the back panel 40. The back panel, more particularly the release layer 20 spans the width 40a and the height 40b of the entire back panel, including behind the front end 42 and the back end 43. The release layer includes a printed grid as at 48 upon a regular interval such as one inch along two axes. The printed grid 48 extends upon the back panel and includes the front end and the back end. The printed grid 48 also includes markings as at 49 to show the left and the top for the primary image when viewed from the front. The markings denote the position of the front end generally to the left and the orientation of the back panel as upright. The markings 49 guide the operator in trimming to remember where the primary image begins even though the operator may not see the primary image located opposite the grid. The printed grid assists the operator in trimming the back panel's width 40a so that it fits the back wall of a closet. Closets may have back walls that vary in width. The method of the present invention recognizes that the back panel 40 is supplied in a sixty inch width while closest may be of lesser width. The printed grid allows an operator with little skill to trim the back panel symmetrically, that is, the same amount off the front end and the back end so that the maximum portion of the center of the primary image remains.

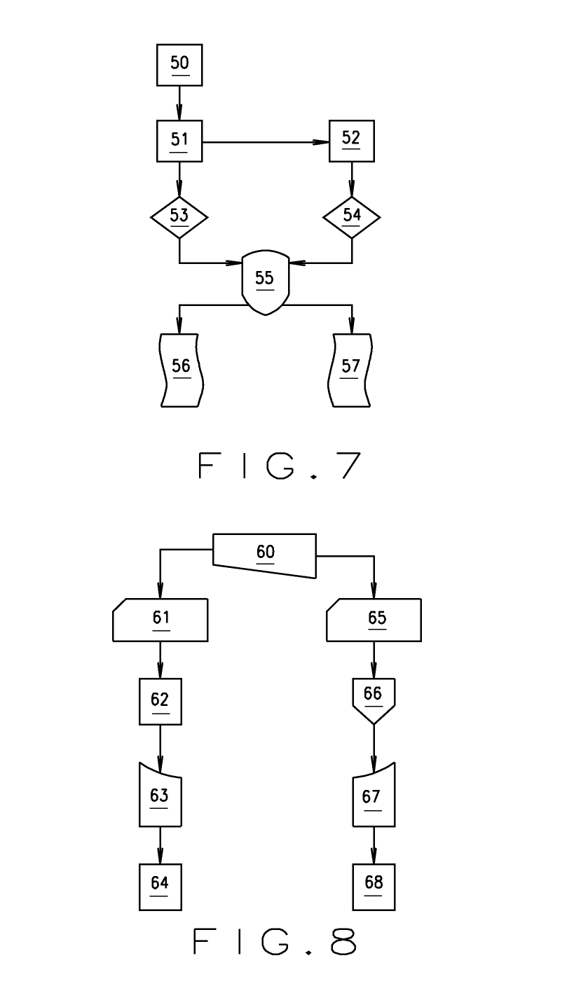

FIG. 7 provides a flow chart of the method of the present invention. The method begins with selecting a pictorial theme as at 50 such as pirate, castle, mountain, space, and the like. From the theme, a primary image is selected as at 51 and a secondary image is selected as at 52. The primary image 44 and the secondary image 45 have their asymmetry and alignment features as described above. Upon the primary image, then identify a front end and a back end as at the step 53, where the back end is spaced apart from the front end. And, upon the secondary image, then identify a front end and a back end as at the step 54, also where the front end and the back end are spaced apart. Then the alignment, or relationship, of the front ends and back ends of the primary and secondary images are checked as at 55. With the alignment checked, the present invention then prints the primary image upon the back panels as at 56 and the secondary image upon the side panels as at 57. The panels are them collected and prepared for shipment to an operator for installation.

FIG. 8 then shows a flow chart for an operator to utilize the present invention. The operator initially measures the width of the back wall and the width of the side walls of a closet. If the operator has selected just a corner location, the operator measures the width of the available wall space. This measurement occurs at step 60. As the old adage reminds us, measure twice and cut once. The operator then trims the back panel 40 utilizing the grid 47 on the back surface 26 as at step 61. The operator then turns the back panel with the primary image out and positions the back panel on the back wall for fit as at 62. The operator then peels back the release layer, as at 63, as previously shown in FIG. 4 from one corner of the back panel. The operator then installs the back panel upright upon the back wall of a closet as at 64. With the back panel in place, the in place, the operator trims the side panels to the desired width as at 65. The operator then aligns an end of a side panel to the nearest end of a back panel as at 66 so that the secondary image relates with the primary image. The operator then peels back the release layer, as at 67, as previously shown in FIG. 4 from one corner of the side panel. The operator then installs the side panel upright upon one of the sides of a closet as at 68. With the back panel and at least one side panel installed, a user such as a child can then play within the closet as in FIG. 2 or near a corner as in FIG. 1 and use his imagination to explore the surrounding and have adventures.

From the aforementioned description, a method for simulating an environment has been described. The method for simulating an environment is uniquely capable of decorating a closet or corner with aligned primary and secondary images. The method for simulating an environment may utilize various components may be manufactured from many materials, including but not limited to, paper, paperboard, textiles, polymers, nylon, polyvinyl chloride, high density polyethylene, polypropylene, flexible metallic alloys, and composite fibers.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third,” “one of,” the other,” and the like are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A method of simulating an environment to a user, the environment having a left, an opposite right, and an upright orientation, comprising:
selecting a pictorial theme;
selecting an asymmetric primary image;
selecting an asymmetric secondary image;
identifying a front upon the primary image and a spaced apart back upon the primary image;
identifying a front upon the secondary image and a spaced apart back upon the secondary image;
checking that the front of the primary image aligns with the back of the secondary image and that the back of the primary image aligns with the front of the secondary image wherein said primary image and said secondary image are adapted to surround a user;
printing the primary image on a back panel, said back panel having a width, a front end and a spaced apart back end; and,
printing the secondary image on a side panel, said side panel having a width, a front end and a spaced apart back end and the width of said side panel being less than the width of said back panel.

2. The environment simulating method of claim 1 further comprising:
providing said back panel as a combination of two or more subpanels.

3. The environment simulating method of claim 1 wherein said front of said primary image has a lesser height than said back of said primary image.

4. The environment simulating method of claim 1 wherein said front on said secondary image has a greater height than said back of said secondary image.

5. The environment simulating method of claim 1 further comprising: said identifying a front upon the primary image and a spaced apart back upon the primary image including said front adapted to correspond with the left of the environment and said back adapted to correspond with the right of the environment.

6. The environment simulating method of claim 1 further comprising:
providing a plurality of decals capable of releasably adhering to the back panel and the side panel, said decals having a contour cut.

7. The environment simulating method of claim 6 further comprising:
said providing a plurality of decals for placement upon said back panel and said side panel, each of said decals including a low tack adhesive.

8. The environment simulating method of claim 1 further comprising:
providing a grid upon said back panel opposite said primary image, said grid denoting a position of said front end of said back panel and said back panel being upright.

9. A method of simulating an environment, the environment having a left, an opposite right, and an upright orientation, comprising:
selecting a pictorial theme having an asymmetric primary image and an asymmetric secondary image;
identifying a front end upon the primary image and a spaced apart back end upon the primary image;
identifying a front end upon the secondary image and a spaced apart back end upon the secondary image;
aligning the front end of the primary image with the back end of the secondary image and the back end of the primary image with the front end of the secondary image;
printing the primary image on a back panel, said back panel having a width, a front end corresponding to the front end of said primary image, a back end corresponding to the back end of said primary image, and printing the secondary image on a side panel, said side panel having a width, a front end corresponding to the front end of said secondary image, a back end corresponding to the back end of said secondary image and the width of said side panel is less than the width of said back panel; and,
installing said side panel generally perpendicular to said back panel as the front end of said side panel adjoins the back end of said back panel and alternatively the back end of said side panel adjoins the front end of said back panel.

10. The environment simulating method of claim 9 further comprising:
providing a plurality of decals for placement upon said back panel and said side panel, each of said plurality of decals including a low tack adhesive and a contour cut, and each of said plurality of decals capable of releasably adhering to the back panel and the side panel, said decals having a contour cut.

11. The environment simulating method of claim 9 further comprising:
providing said back panel as a combination of two or more subpanels.

12. A method of simulating an environment, said method forming a surrounding in a closet or a corner using a wall that simulates an environment and allows the exploration of imagination through interactive illustrations, the surrounding utilizing a back panel and at least one side panel, said back panel having a substrate with a front surface visible to a user and an opposite rear surface upon the wall, an ink layer upon the front surface, a clear coating upon the ink layer and an adhesive upon the rear surface beneath a release layer, each of said at least one side panel having a substrate with a front surface visible to a user and an opposite rear surface upon the wall, an ink layer upon the front surface, a coating upon the ink layer and an adhesive upon the rear surface beneath a release layer, the surrounding having a pictorial theme, wherein the improvement comprises:
selecting an asymmetric primary image for the front surface of said back panel;
selecting an asymmetric secondary image for the front surface of each of said at least one side panel;
identifying a front end upon the primary image and a spaced apart back end upon the primary image, and said front end adapted to correspond with the left of the environment and said back end adapted to correspond with the right of the environment;
identifying a front end upon the secondary image and a spaced apart back end upon the secondary image;
checking that the front end of the primary image aligns with the back end of the secondary image and that the back end of the primary image aligns with the front end of the secondary image;
printing the primary image on said back panel, said back panel having a width;
printing the secondary image on said at least one side panel, said side panel having a width less than the width of said back panel; and,
providing a grid upon said back panel opposite said primary image, said grid denoting a position of said front end of said back panel and said back panel being upright.

13. The environment simulating method of claim 12 further comprising:
providing said back panel as a combination of two or more subpanels.

14. The environment simulating method of claim 12 further comprising:
installing said side panel generally perpendicular to said back panel as the front end of said side panel adjoins the back end of said back panel and alternatively the back end of said side panel adjoins the front end of said back panel.

15. The environment simulating method of claim 12 further comprising:
providing said back panel as a combination of two or more subpanels;
providing two of said side panels; and,
installing each of said side panels generally perpendicular to said back panel and spacing apart said side panels as the front end of one of said side panels adjoins the back end of said back panel and the back end of the other of said side panel adjoins the front end of said back panel.
